(19) United States
(12) Patent Application Publication
(10) Pub. No.: US 2011/0267387 A1
(43) Pub. Date: Nov. 3, 2011

(54) CIRCUIT AND METHOD FOR DRIVING A LIGHT EMITTING DIODE FOR A BACKLIGHT, AND BACKLIGHT DRIVING APPARATUS USING THE SAME

(75) Inventors: Seung-beom Baik, Cheongju-si (KR); Mi-jin Kim, Cheongju-si (KR); Eung-suen Kim, Cheongju-si (KR); Du-su Shin, Cheongju-si (KR)

(73) Assignee: MAGNACHIP SEMICONDUCTOR, LTD., Cheongju-si (KR)

(21) Appl. No.: 13/049,705

(22) Filed: Mar. 16, 2011

(30) Foreign Application Priority Data
Apr. 30, 2010 (KR) 10-2010-0040882

(51) Int. Cl. G09G 5/10; G09G 3/30

(52) U.S. Cl. 345/691; 345/690; 345/76

(57) ABSTRACT

A circuit and method for driving a light emitting diode for a backlight, and a backlight driving apparatus using the same is provided. A circuit for driving a light emitting diode (LED) for a backlight includes a filtering unit configured to receive a pulse width modulation (PWM) signal and remove noise of a predetermined band, a duty stabilization unit configured to stabilize a duty of a PWM signal filtered by the filtering unit, a dimming signal generation unit configured to generate a dimming signal based on a PWM signal stabilized by the duty stabilization unit, and an LED driving unit configured to drive the LED for the backlight based on the dimming signal generated by the dimming signal generation unit.

### CROSS-REFERENCE TO RELATED APPLICATIONS

This application claims the benefit under 35 U.S.C. §119(a) of Korean Patent Application No. 10-2010-0040882, filed on Apr. 30, 2010, the entire disclosure of which is incorporated herein by reference for all purposes.

### BACKGROUND

1. Field

The following description relates to a circuit for driving a light emitting diode (LED) for a backlight, and more particularly, to a circuit and a method for driving an LED for a backlight, which can stably maintain the brightness of the LED by substantially preventing the occurrence of a flicker, and a backlight driving apparatus using the same.

2. Description of the Related Art

A liquid crystal display (LCD), which is a representative flat panel display, displays images by using the electrical and optical properties of liquid crystal. The LCD has been extensively used due to the advantages of slimness, lightweight, low power consumption, and a low driving voltage, as compared with other display apparatuses. However, since a liquid crystal display panel for displaying images is a non-emissive device, the LCD requires a separate backlight for supplying light to the liquid crystal display panel.

A backlight mainly uses one of a cold cathode fluorescent lamp (CCFL) and an LED. Since a backlight using the CCFL uses mercury, it is harmful to environment and has a slow response speed. Furthermore, it has disadvantages of low color reproduction and generation of preset white light.

Meanwhile, a backlight using the LED is advantageous in that dangerous substances are not used, fast response is possible, and impulsive driving is possible. Furthermore, it has superior color reproduction, and may freely adjust color coordinates and luminance of light by controlling the light amount of red, blue and green LEDs. Since such an LED backlight produces white light by appropriately mixing red light, blue light and green light with one another, the LED backlight includes a plurality of red LED arrays for emitting red light, a plurality of blue LED arrays for emitting blue light, and a plurality of green LED arrays for emitting green light.

The LED backlight adjusts the brightness of the LED by using a dimming method. The dimming method includes an analog dimming method and a digital dimming method. According to the analog dimming method, the brightness of the LED is adjusted by controlling the amount of a current supplied to each LED for the backlight. In the case of the analog dimming method, if the amount of the current supplied to each LED for the backlight is reduced by 50%, the brightness of each LED for the backlight is reduced by 50%. According to the digital dimming method, for example, a pulse width modulation (PWM) dimming method, the brightness of each LED for the backlight is adjusted by controlling the ratio of on-off time of each LED for the backlight in response to a PWM signal.

An LED driving apparatus using the PWM dimming method adjusts the brightness of an LED by controlling a current flowing through an LED array. The LED driving apparatus includes a controller or a microcontroller unit (MCU) for transmitting a PWM signal for current control to an LED driving circuit. When the controller or the MCU generates the PWM signal for adjusting the brightness of the LED and provides the LED driving circuit with the PWM signal, the PWM signal is affected by undesired external electromagnetic interference (EMI), resulting in the distortion of a duty ratio of the PWM signal. This causes noise and thus flickering of the LED occurs. Therefore, the brightness of the LED may not be stably maintained.

In the related art, in order to stably adjust the brightness of the LED, noise is removed from the PWM signal by using an analog filter. According to such a method using the analog filter, instantaneously applied high frequency noise may be removed using a low pass filter. Furthermore, low frequency noise in the filter band may be removed. However, when the duty of the PWM signal is distorted, noise may not be removed and a flicker may occur due to the instability in the brightness of the LED.

### SUMMARY

In one general aspect, there is provided a circuit for driving a light emitting diode (LED) for a backlight, the circuit including a filtering unit configured to receive a pulse width modulation (PWM) signal and remove noise of a predetermined band, a duty stabilization unit configured to stabilize a duty of a PWM signal filtered by the filtering unit, a dimming signal generation unit configured to generate a dimming signal based on a PWM signal stabilized by the duty stabilization unit, and an LED driving unit configured to drive the LED for the backlight based on the dimming signal generated by the dimming signal generation unit.

The circuit may further include that the filtering unit includes a low pass filter configured to remove noise of a high frequency band.

The circuit may further include that the filtering unit further includes a resistor-capacitor (RC) filter.

The circuit may further include that the filtering unit is configured to perform a hysteresis function to substantially prevent change in a direct current (DC) level of the PWM signal.

The circuit may further include that the duty stabilization unit is configured to sample the PWM signal, count the sampled PWM signal, and average the duty of the PWM signal.

The circuit may further include that the duty stabilization unit is configured to sample the PWM signal in synchronization with a clock signal.

The circuit may further include that the duty stabilization unit is configured to sample the PWM signal of at least two periods.

The circuit may further include that the duty stabilization unit includes a digital filter.

The circuit may further include that the duty stabilization unit further includes an accumulator configured to count the sampled PWM signal.

The circuit may further include that the LED driving unit further includes a metal-oxide-semiconductor (MOS) transistor coupled to the LED, the MOS transistor being configured to be driven based on the dimming signal from the dimming signal generation unit.

The circuit may further include a current control unit configured to adjust a current flowing through the LED, and a switching unit configured to provide the LED driving unit with an output signal of the current control unit based on the dimming signal from the dimming signal generation unit.

In another general aspect, there is provided a backlight driving apparatus, including a light emitting diode (LED) array for a backlight, a pulse width modulation (PWM) signal generator configured to generate a PWM signal, a direct current-direct current (DC-DC) converter configured to provide a voltage for driving the LED array for the backlight based on the PWM signal of the PWM signal generator, and an LED driving circuit configured to receive the PWM signal from the PWM signal generator, stabilize a duty of the PWM signal, and generate a dimming signal, the dimming signal being configured to drive the LED array for the backlight based on the PWM signal having the stabilized duty, the LED driving circuit including a duty stabilization unit configured to sample the PWM signal, count the sampled PWM signal, and average the duty of the PWM signal.

The backlight driving apparatus may further include that the duty stabilization unit includes a digital filter configured to accumulate the sampled PWM signal.

The backlight driving apparatus may further include that the duty stabilization unit is configured to sample the PWM signal in synchronization with a clock signal.

The backlight driving apparatus may further include that the duty stabilization unit is configured to sample the PWM signal of at least two periods.

The backlight driving apparatus may further include that the LED driving circuit further includes a filtering unit configured to receive the PWM signal, filter noise of a predetermined band and change in a direct current (DC) level of the PWM signal, and provide the filtered PWM signal to the duty stabilization unit.

The backlight driving apparatus may further include that the filtering unit includes a low pass filter configured to perform a hysteresis function.

The backlight driving apparatus may further include that the LED driving circuit further includes a dimming signal generation unit configured to receive the PWM signal having the stabilized duty from the duty stabilization unit, and generate the dimming signal, and an LED driving unit configured to drive the LED array for the backlight based on the dimming signal from the dimming signal generation unit.

In another general aspect, there is provided a method for driving a light emitting diode (LED) for a backlight, including filtering a pulse width modulation (PWM) signal, stabilizing a duty of the filtered PWM signal, generating a dimming signal with a constant duty from the PWM signal having the stabilized duty, and driving the LED for the backlight based on the dimming signal.

The method may further include that the filtering of the PWM signal includes removing change in a direct current (DC) level of the PWM signal.

The method may further include that the filtering of the PWM signal includes low-pass filtering the PWM signal.

The method may further include that the stabilizing of the duty includes sampling the PWM signal, and counting and averaging the sampled PWM signal.

The method may further include that the sampling of the PWM signal includes sampling the PWM signal in synchronization with a clock signal.

The method may further include that the sampling of the PWM signal includes sampling the PWM signal of at least two periods.

Other features and aspects may be apparent from the following detailed description, the drawings, and the claims.

### BRIEF DESCRIPTION OF THE DRAWINGS

FIG. 1 is an example of a block diagram of a backlight driving apparatus.

FIG. 2 is an example of a detailed circuit diagram of the backlight driving apparatus illustrated in FIG. 1.

FIG. 3 is an example of a diagram illustrating an operation waveform of the backlight driving apparatus illustrated in FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

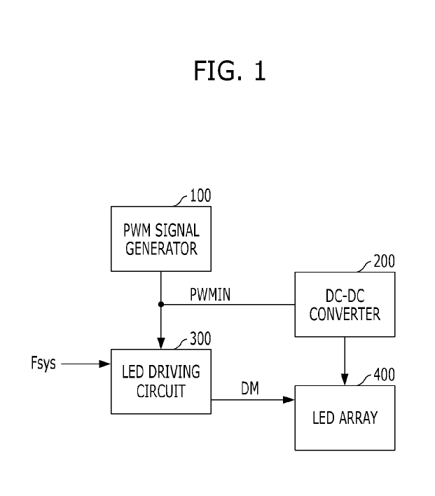

FIG. 1 is an example of a block diagram illustrating the configuration of a backlight driving apparatus. Referring to FIG. 1, the backlight driving apparatus includes a pulse width modulation (PWM) signal generator 100, a direct current-direct current (DC-DC) converter 200, a light emitting diode (LED) driving circuit 300, and an LED array 400.

The PWM signal generator 100 is configured to generate a PWM signal PWMIN with a predetermined duty ratio and provide the DC-DC converter 200 with the PWM signal PWMIN. The PWM signal generator 100 may include a controller or a microcontroller unit (MCU). The DC-DC converter 200 is configured to receive the PWM signal PWMIN from the PWM signal generator 100 and provide the LED array 400 for a backlight with an output voltage for driving an LED. The DC-DC converter 200 may include a boost-up converter that is configured to generate a desired high voltage by boosting up an input voltage, and provide the LED array 400 for the backlight with the high voltage.

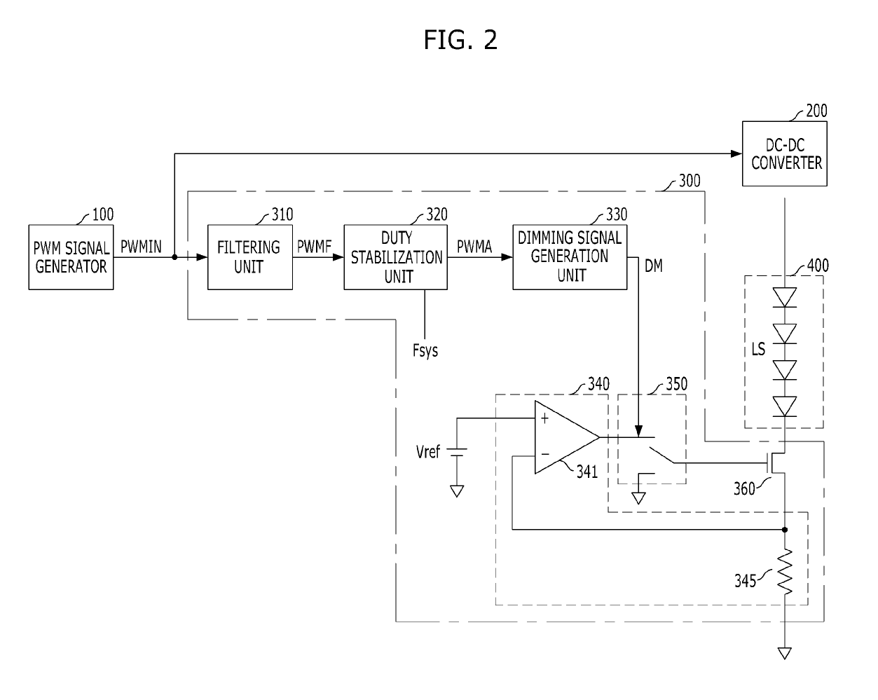

The LED driving circuit 300 is configured to receive the PWM signal PWMIN from the PWM signal generator 100, generate a dimming signal for adjusting the brightness of the LED, and provide the LED array 400 for the backlight with the dimming signal. As illustrated in FIG. 2, the LED array 400 may include an LED string LS in which a plurality of LEDs are serially coupled to one another. In FIG. 2, the LED array 400 includes one LED string. However, a plurality of LED strings may be coupled parallel to one another.

FIG. 2 is an example of a detailed diagram of the backlight driving apparatus of FIG. 1, which is a detailed circuit diagram of the LED driving circuit 300. Referring to FIG. 2, the LED driving circuit 300 includes a filtering unit 310, a duty stabilization unit 320, a dimming signal generation unit 330, a current control unit 340, a switching unit 350, and an LED driving unit 360.

The filtering unit 310 is configured to receive the PWM signal PWMIN from the PWM signal generator 100 and output only a frequency signal of a desired band of the PWM signal PWMIN. The filtering unit 310 may include a low pass filter that removes signals of a high frequency band to ensure a noise margin. The filtering unit 310 may include a resistor-capacitor (RC) filter as an analog filter. The filtering unit 310 additionally performs a hysteresis function, thereby ensuring a noise margin for change in the DC level of the PWM signal PWMIN.

The duty stabilization unit 320 is configured to stabilize the duty of the PWM signal filtered by the filtering unit 310. The duty stabilization unit 320 is configured to average the duty distortion of the filtered PWM signal and may include a digital filter. The duty stabilization unit 320 may include an accumulator that counts information on the duty of the PWM signal. The duty stabilization unit 320 is configured to sample the duty of the PWM signal by using a system clock Fsys for a predetermined time and calculate an average value by counting the sampled duty. Consequently, the duty stabilization unit 320 may generate a PWM signal with a stabilized duty.

The dimming signal generation unit 330 is configured to receive an output signal of the duty stabilization unit 320 and generate a dimming signal DM for driving the LED string LS of the LED array 400. Since the LED array 400 for the backlight includes only one LED string LS, only one dimming signal DM is generated. However, when the LED array 400 includes a plurality of LED strings, a plurality of dimming signals may be generated and provided to the LED strings, respectively.

The dimming signal DM is used for turning on and off the LED string LS of the LED array 400 and has a duty of approximately 0% to approximately 100%. The duty of dimming signal DM may be calculated by Equation 1 as provided below.

Duty DPWM=HTFPWM/TFPWM (1)

In Equation 1, the HTFPWM represents a high level time of a sampled PWM signal when the duty stabilization unit 320 samples the PWM signal filtered by the filtering unit 310 in synchronization with the system clock. The TFPWM represents the total sampling time of the PWM signal. The TFPWM may include a sampling time of a PWM signal of at least two periods.

The current control unit 340 is configured to control a current flowing through the LED string LS of the LED array 400. The current control unit 340 may include an operation amplifier 341 and a current limit resistor 345. The operation amplifier 341 has a non-inversion terminal to which a reference voltage Vref is applied, and an inversion terminal to which an output terminal thereof is feedback coupled. The current limit resistor 345 is coupled to the inversion terminal of the operation amplifier 341.

The current flowing through the LED string LS may be expressed by Equation 2 as provided below.

I(LED)=Vref/R (2)

In Equation 2, the Vref represents the reference voltage provided to the non-inversion terminal of the operation amplifier 341 and the R represents a resistance value of the resistor 345.

The switching unit 350 is configured to provide an output signal of the current control unit 340 to the LED driving unit 360 based on the dimming signal DM from the dimming signal generation unit 330. The switching unit 350 may include a switch that is controlled by the dimming signal DM.

The LED driving unit 360 is configured to drive the LED string LS of the LED array 400 in response to the output signal of the current control unit 340, which is provided through the switching unit 350. The LED driving unit 360 may include a metal-oxide-semiconductor (MOS) transistor having a drain coupled to one terminal of the LED string LS of the LED array 400, a source coupled to the current control unit 340, and a gate that receives the output signal of the current control unit 340 through the switching unit 350.

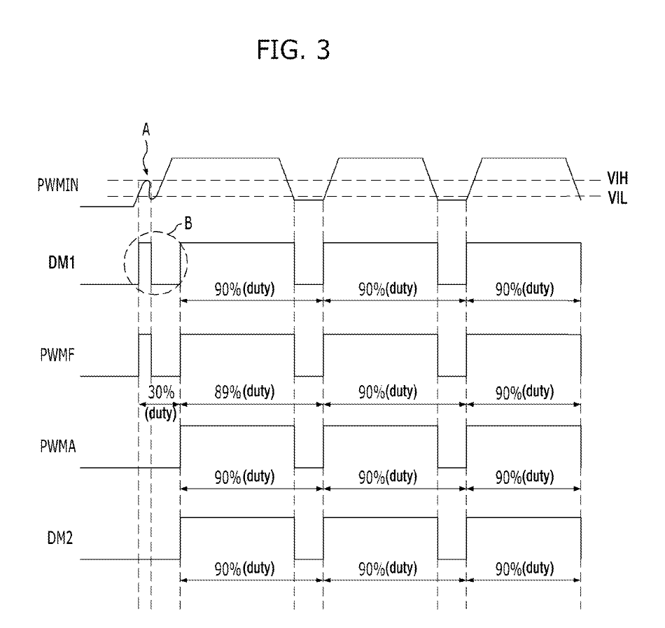

The operation of the LED driving apparatus illustrated in FIGS. 1 and 2 will be described with reference to FIG. 3 illustrating operation waveforms.

The PWM signal PWMIN is generated by the PWM signal generator 100 and is provided to the DC-DC converter 200. The DC-DC converter 200 is configured to generate the desired high voltage by boosting up the input voltage and provide the LED array 400 with the high voltage.

Meanwhile, the PWM signal PWMIN is provided to the LED driving circuit 300 from the PWM signal generator 100. When noise or duty distortion occurs in the PWM signal PWMIN, the filtering unit 310 performs a filtering operation for removing a high frequency noise of the PWM signal PWMIN and simultaneously ensuring a DC noise margin. Thus, the filtering unit 310 provides the filtered PWM signal PWMF to the duty stabilization unit 320.

The duty stabilization unit 320 is configured to sample the PWM signal PWMF, from which the noise is removed by the filtering unit 310, in synchronization with the system clock signal Fsys. In FIG. 3, the filtered PWM signal PWMF is sampled for three periods of the PWM signal. However, the PWM signal may be sampled for at least two periods. The duty stabilization unit 320 is configured to calculate an average value by counting the duty of the sampled PWM signal. The average value is calculated by Equation 1 above, which is obtained by adding all logic high durations to one another in the total duty average section. Subsequently, a PWM signal PWMA with a uniform duty for the next duty average calculation section is generated. Thus, the duty stabilization unit 320 provides the dimming signal generation unit 330 with the PWM signal PWMA with the uniform duty as illustrated in FIG. 3.

The dimming signal generation unit 330 is configured to receive the PWM signal PWMA with the stabilized duty from the duty stabilization unit 320 and output a stable dimming signal DM2. When the duty stabilization unit 320 is not provided, as with the related art, a dimming signal with a non-uniform duty such as a dimming signal DM1 may occur due to a portion A at which the duty of the PWM signal is distorted. Therefore, a flicker may occur at a portion B at which the duty of the dimming signal DM1 is non-uniform.

In FIG. 3, VIH (Voltage of Input High) represents an ‘input high threshold voltage’ to determine a ‘high’ logic state. If an input voltage is higher than VIH, the logic state is determined to be a high logic state. VIL (Voltage of Input Low) represents an ‘input low threshold voltage’ to determine a ‘low’ logic state. If an input voltage is lower than VLH, the logic state is determined to be a low voltage state.

That is, as illustrated in FIG. 3, if the voltage of a PWMIN signal increases to be higher than VIH, the logic state is determined to be a high state. Therefore, a signal generated by glitch or signal is also recognized as PWM duty information and a duty of one frequency (30% duty) as illustrated in portion ‘B’.

In contrast, when the duty stabilization unit 320 is provided, even if the PWM signal PWMIN with a distorted duty is provided, the dimming signal DM2 with the uniform duty may be generated by the duty averaging operation of the duty stabilization unit 320.

The switch of the switching unit 350 is turned on and off based on the dimming signal DM2 and the MOS transistor of the LED driving unit 360 is driven by the current control unit 340. As the MOS transistor is driven, the LED string LS of the LED array 400 is driven. Current flows through the LED array 400 including the LED string LS, so that the desired brightness of the LEDs may be stably maintained.

Thus, even if the PWM signal PWMIN with a distorted duty is applied, the dimming signal generation unit 330 may generate the dimming signal DM2 with the uniform duty through the duty averaging operation of the duty stabilization unit 320. Consequently, the brightness of the LEDs is constantly maintained regardless of the portion A at which the duty of the PWM signal PWMIN is distorted, so that the occurrence of a flicker may be substantially prevented.

Since the resistor 345 of the current control unit 340 limits the current flowing through the LED string LS, and the current flowing through the LED string LS is fed back to the inversion terminal of the operation amplifier 341, the current flowing through the LED string LS may be constantly maintained.

According to general aspects of a circuit and a method for driving an LED for a backlight, even if external noise occurs or a duty of a PWM signal is distorted, the duty of the PWM signal is sampled, counted and averaged and thus the duty of the PWM signal is stabilized. Consequently, a dimming signal with a uniform duty is generated, so that the occurrence of a flicker may be substantially prevented and the brightness of an LED may be stably maintained.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A circuit for driving a light emitting diode (LED) for a backlight, the circuit comprising:
a filtering unit configured to:
receive a pulse width modulation (PWM) signal; and
remove noise of a predetermined band;
a duty stabilization unit configured to stabilize a duty of a PWM signal filtered by the filtering unit;
a dimming signal generation unit configured to generate a dimming signal based on a PWM signal stabilized by the duty stabilization unit; and
an LED driving unit configured to drive the LED for the backlight, based on the dimming signal generated by the dimming signal generation unit.

2. The circuit of claim 1, wherein the filtering unit comprises a low pass filter configured to remove noise of a high frequency band.

3. The circuit of claim 2, wherein the filtering unit further comprises a resistor-capacitor (RC) filter.

4. The circuit of claim 2, wherein the filtering unit is further configured to perform a hysteresis function to substantially prevent change in a direct current (DC) level of the PWM signal.

5. The circuit of claim 1, wherein the duty stabilization unit is further configured to:
sample the PWM signal;
count the sampled PWM signal; and
average the duty of the PWM signal.

6. The circuit of claim 5, wherein the duty stabilization unit is further configured to sample the PWM signal in synchronization with a clock signal.

7. The circuit of claim 6, wherein the duty stabilization unit is further configured to sample the PWM signal of at least two periods.

8. The circuit of claim 5, wherein the duty stabilization unit comprises a digital filter.

9. The circuit of claim 8, wherein the duty stabilization unit further comprises an accumulator configured to count the sampled PWM signal.

10. The circuit of claim 1, wherein the LED driving unit further comprises a metal-oxide-semiconductor (MOS) transistor coupled to the LED, the MOS transistor being configured to be driven based on the dimming signal from the dimming signal generation unit.

11. The circuit of claim 1, further comprising:
a current control unit configured to adjust a current flowing through the LED; and
a switching unit configured to provide the LED driving unit with an output signal of the current control unit based on the dimming signal from the dimming signal generation unit.

12. A backlight driving apparatus, comprising:
a light emitting diode (LED) array for a backlight;
a pulse width modulation (PWM) signal generator configured to generate a PWM signal;
a direct current-direct current (DC-DC) converter configured to provide a voltage for driving the LED array for the backlight based on the PWM signal of the PWM signal generator; and
an LED driving circuit configured to:
receive the PWM signal from the PWM signal generator;
stabilize a duty of the PWM signal; and
generate a dimming signal, the dimming signal being configured to drive the LED array for the backlight based on the PWM signal having the stabilized duty, the LED driving circuit comprising a duty stabilization unit configured to:
sample the PWM signal;
count the sampled PWM signal; and
average the duty of the PWM signal.

13. The backlight driving apparatus of claim 12, wherein the duty stabilization unit comprises a digital filter configured to accumulate the sampled PWM signal.

14. The backlight driving apparatus of claim 12, wherein the duty stabilization unit is further configured to sample the PWM signal in synchronization with a clock signal.

15. The backlight driving apparatus of claim 13, wherein the duty stabilization unit is further configured to sample the PWM signal of at least two periods.

16. The backlight driving apparatus of claim 12, wherein the LED driving circuit further comprises a filtering unit configured to:
receive the PWM signal;
filter noise of a predetermined band and change in a direct current (DC) level of the PWM signal; and
provide the filtered PWM signal to the duty stabilization unit.

17. The backlight driving apparatus of claim 16, wherein the filtering unit comprises a low pass filter configured to perform a hysteresis function.

18. The backlight driving apparatus of claim 12, wherein the LED driving circuit further comprises:
a dimming signal generation unit configured to receive the PWM signal having the stabilized duty from the duty stabilization unit, and generate the dimming signal; and
an LED driving unit configured to drive the LED array for the backlight based on the dimming signal from the dimming signal generation unit.

19. A method for driving a light emitting diode (LED) for a backlight, comprising:
filtering a pulse width modulation (PWM) signal;
stabilizing a duty of the filtered PWM signal;
generating a dimming signal with a constant duty from the PWM signal having the stabilized duty; and
driving the LED for the backlight based on the dimming signal.

20. The method of claim 19, wherein the filtering of the PWM signal comprises removing change in a direct current (DC) level of the PWM signal.

21. The method of claim 19, wherein the filtering of the PWM signal comprises low-pass filtering the PWM signal.

22. The method of claim 19, wherein the stabilizing of the duty comprises:
sampling the PWM signal; and
counting and averaging the sampled PWM signal.

23. The method of claim 22, wherein the sampling of the PWM signal comprises sampling the PWM signal in synchronization with a clock signal.

24. The method of claim 23, wherein the sampling of the PWM signal comprises sampling the PWM signal of at least two periods.
